(19) United States
(12) Patent Application Publication
(10) Pub. No.: US 2022/0186338 A1
(43) Pub. Date: Jun. 16, 2022

(54) METHOD FOR PRODUCING NON-ORIENTED ELECTRICAL STEEL SHEET

(71) Applicant: JFE STEEL CORPORATION, Tokyo (JP)

(72) Inventors: Yusuke SHIMOYAMA, Tokyo (JP); Yukihiro SHINGAKI, Tokyo (JP); Yoshiaki ZAIZEN, Tokyo (JP); Hiroi YAMAGUCHI, Tokyo (JP)

(73) Assignee: JFE STEEL CORPORATION, Tokyo (JP)

(21) Appl. No.: 17/603,239

(22) PCT Filed: Jan. 17, 2020
(86) PCT No.: PCT/JP2020/001450

§ 371 Date: Oct. 12, 2021

(30) Foreign Application Priority Data
Apr. 22, 2019 (JP) 2019-081033

(51) Int. Cl. C21D 9/46; C21D 8/12; C22C 38/00; C22C 38/02; C22C 38/04; C22C 38/06

(52) U.S. Cl. CPC C21D 9/46; C21D 8/1222; C21D 8/1233; C21D 8/1266; C21D 8/1261; C22C 38/004; C22C 38/001; C22C 38/002; C22C 38/02; C22C 38/04; C22C 38/06; C21D 8/1272

(57) ABSTRACT

A method for producing a non-oriented electrical steel sheet used as an iron core material for a motor or transformer and having excellent magnetic properties including subjecting a raw steel material including, by mass %, C: not more than 0.005%, Si: 1.0 to 5.0%, Mn: 0.04 to 3.0%, sol. Al: not more than 0.005%, P: not more than 0.2%, S: not more than 0.005%, N: not more than 0.005% and the remainder being Fe and impurities forming a hot-rolled sheet, subjecting the hot-rolled sheet to hot-band annealing and a single or two or more cold rollings including an intermediate annealing between each rolling forming a cold-rolled sheet having a final sheet thickness and subjecting the cold-rolled sheet to a finish annealing, wherein at least one pass in the final cold rolling at a friction coefficient μ of not less than 0.030 and a rolling reduction of not less than 15%.

### TECHNICAL FIELD

This invention relates to a method for producing a non-oriented electrical steel sheet used as an iron core material for a motor or a transformer and having excellent magnetic properties.

### BACKGROUND ART

Non-oriented electrical steel sheets are soft magnetic material widely used as an iron core material for a motor, a transformer or the like. Recently, the non-oriented electrical steel sheets have been strongly required to have a lower iron loss and higher magnetic flux density in view of growing demand to energy saving.

In order to reduce the iron loss, it is effective to increase contents of

Si, Al and the like enhancing the electric resistance of steel. It is due to the fact that as the electric resistance becomes larger, eddy current loss generated by magnetizing steel sheet is decreased. However, an addition of a great amount of Si or Al brings about decrease in the magnetic flux density, causing a new problem that torque of the motor is reduced or copper loss is increased.

Therefore, apart from the above method, research and development for improvement of the texture of the steel sheet to increase the magnetic flux density have been actively made from the past. A method of increasing the magnetic flux density includes, for example, a method of increasing crystal faces including a magnetization easy axis in a plane of the steel sheet, concretely a method in which {111} orientation grains including no magnetization easy axis is reduced and {110} and {100} orientation grains including the magnetization easy axis are increased in the plane of the steel sheet.

As a method of developing such a texture, for example, Patent Literature 1 proposes a method of decreasing Al content as much as possible and then conducting warm rolling in cold rolling, and Patent Literature 2 proposes a method of adding P to steel and conducting a batch annealing at a low temperature for a long time before cold rolling. Also, Patent Literature 3 proposes a method of increasing an integration degree of {110}<001> orientation by performing a hot rolling under special conditions, concretely a method of highly integrating the orientation into {510}<001> orientation and thus developing {110}<001> orientation by utilizing the integrated {510}<001> orientation.

### CITATION LIST

### Patent Literature

Patent Literature 1: JP-A-2002-003944

Patent Literature 2: JP-A-2005-200756

Patent Literature 3: JP-A-2000-160248

### SUMMARY OF INVENTION

### Technical Problem

However, the above conventional techniques still have the following problems to be solved. For example, the method proposed in Patent Literature 1 can obtain an effect of improving the magnetic flux density to some extent, but needs to be further improved to meet severe demand to the magnetic properties in recent years. The method proposed in Patent Literature 2 needs a batch annealing at a low temperature for a long time, causing a problem of a decrease in productivity and an increase in production costs. In the method proposed in Patent Literature 3, the finish sheet thickness in hot rolling is necessary to be as thin as 0.8 mm, as disclosed in the examples. In order to produce a hot-rolled sheet having such a sheet thickness, it is necessary to use a special hot rolling installation which can keep a given temperature over a full length of a coil and is durable to a large rolling load, leading to an increase in production costs and a decrease in productivity. Therefore, there are many problems in applying these production methods to actual operations.

The invention is made in consideration of the above problems inherent to the conventional techniques, and an object thereof is to propose a method for producing a non-oriented electrical steel sheet capable of stably producing a non-oriented electrical steel sheet having a high magnetic flux density and a low iron loss without causing an increase in production costs.

### Solution to Problem

The inventors have made various studies on the method of improving magnetic properties of a non-oriented electrical steel sheet with focusing on an influence of cold rolling upon the texture of a product sheet. As a result, they have found out that, by increasing a friction coefficient μ in rolling to not less than 0.030 to conduct the final cold rolling, crystal rotation is caused from {111} orientation which is disadvantageous to {110}<001> orientation which is advantageous to the magnetic properties thus to develop a texture favorable to the magnetic properties in finish annealing, whereby the non-oriented electrical steel sheet having a high magnetic flux density and a low iron loss can be obtained, and the invention has been accomplished.

That is, the invention proposes a method for producing a non-oriented electrical steel sheet comprising a series of steps of:

subjecting a raw steel material having a component composition comprising C: not more than 0.005 mass %, Si: 1.0 to 5.0 mass %, Mn: 0.04 to 3.0 mass %, sol. Al: not more than 0.005 mass %, P: not more than 0.2 mass %, S: not more than 0.005 mass %, N: not more than 0.005 mass % and the remainder being Fe and inevitable impurities to a hot rolling to form a hot-rolled sheet,

subjecting the hot-rolled sheet to a hot-band annealing and then to a single cold rolling or two or more cold rollings including an intermediate annealing between each cold rolling to form a cold-rolled sheet having a final sheet thickness, and

subjecting the cold-rolled sheet to a finish annealing,

in which

at least one pass in a final cold rolling of the cold rolling is a rolling conducted at a friction coefficient μ of not less than 0.030 and a rolling reduction of not less than 15%, where the final cold rolling refers to, when the final sheet thickness is achieved by a single cold rolling, the single cold rolling, or when the final sheet thickness is achieved by two or more cold rollings including an intermediate annealing between each rolling, the last cold rolling conducted after the last intermediate annealing.

In the method for producing the non-oriented electrical steel sheet according to the invention, it is preferable to use a rolling oil having a kinetic viscosity v₅₀ at 50° C. of not more than 40 mm²/s in the final cold rolling.

In the method for producing the non-oriented electrical steel sheet according to the invention, the raw steel material is preferable to contain one or more selected from Sn: 0.005 to 0.2 mass %, Sb: 0.005 to 0.2 mass %, REM: 0.0005 to 0.02 mass %, Mg: 0.0005 to 0.02 mass % and Ca: 0.0005 to 0.02 mass % in addition to the above component composition.

### Advantageous Effects of Invention

According to the invention, a non-oriented electrical steel sheet having a high magnetic flux density and a low iron loss can be produced stably without increasing production costs. Therefore, the non-oriented electrical steel sheet obtained in the invention can be used favorably as an iron core material for motors, transformers and the like.

### BRIEF DESCRIPTION OF DRAWINGS

FIG. 1 is a graph showing an influence of a kinetic viscosity v₅₀ of a rolling oil supplied to a 4-stand tandem cold rolling mill upon a friction coefficient μ of each stand.

### DESCRIPTION OF EMBODIMENT

The invention is a method for producing a non-oriented electrical steel sheet comprising cold rolling a hot-rolled steel sheet for a non-oriented electrical steel sheet to form a cold-rolled sheet having a final sheet thickness and subjecting the cold-rolled sheet to a finish annealing, in which at least one pass in the cold rolling conducted to achieve the final sheet thickness (final cold rolling) is performed by rolling at a friction coefficient μ of not less than 0.030 and a rolling reduction per one pass of not less than 15%, whereby, in a product sheet, an abundance ratio of grains of {111}<112> orientation which are disadvantageous to the magnetic properties is reduced and an abundance ratio of grains of {110}<001> orientation which are advantageous to the magnetic properties is increased to produce a non-oriented electrical steel sheet having excellent magnetic properties.

There will be described experiments that have led to development of the invention below.

To improve magnetic properties of a non-oriented electrical steel sheet, first, the inventors have made the following experiments to investigate an influence of cold rolling conditions, particularly a friction coefficient in the final cold rolling to achieve the final sheet thickness upon a texture of a product sheet.

<Experiment 1>

In order to investigate an influence of properties of a rolling oil used in cold rolling upon a friction coefficient in the rolling, a hot-rolled sheet containing 3.2 mass % Si and having a sheet thickness of 1.6 mm is rolled to a cold-rolled sheet having a sheet thickness of 0.18 mm according to a pass schedule shown in Table 1 using a 4-stand tandem cold rolling mill, during which a friction coefficient μ in each stand (pass) is measured by variously changing a kinetic viscosity v₅₀ at 50° C. of the rolling oil supplied to each stand within a range of 10 to 50 mm²/s. Here, the kinetic viscosity v₅₀ of the rolling oil is a value calculated by the method according to JIS Z8803:2011 with a ductular viscometer. Also, the friction coefficient μ is calculated from a rolling load in the rolling.

TABLE 1

| | Rolling conditions of each stand | | | |
|---|---|---|---|---|
| | No. 1 | No. 2 | No. 3 | No. 4 |
| | stand | stand | stand | stand |
| Sheet thickness at entry side (mm) | 1.60 | 1.20 | 0.60 | 0.30 |
| Sheet thickness at exit side (mm) | 1.20 | 0.60 | 0.30 | 0.18 |
| Rolling reduction (%) | 25.0 | 50.0 | 50.0 | 40.0 |

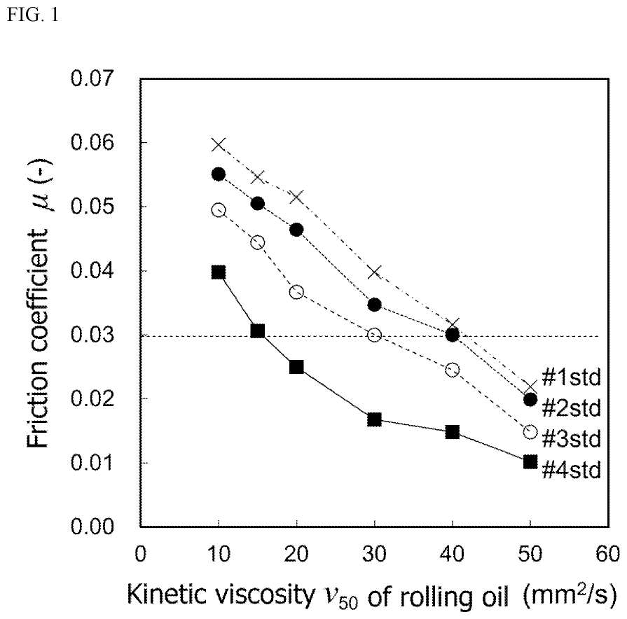

The measurement results are shown in FIG. 1. In FIG. 1, #Nstd (N is numeral of 1 to 4) represents N-th stand from an entry of the tandem cold rolling mill. For example, #1std corresponds to No. 1 stand. As seen from this figure, the friction coefficient μ in the rolling and the kinetic viscosity v₅₀ of the rolling oil have an extremely good negative correlation, and the friction coefficient μ can be enhanced by reducing the kinetic viscosity v₅₀. For example, when the rolling oil having a kinetic viscosity v₅₀ at 50° C. of 40 mm²/s is used, the friction coefficient μ can be made to not less than 0.030 only in No. 1 and 2 stands, while when the rolling oil having a kinetic viscosity v₅₀ at 50° C. of 15 mm²/s is used in the all stands, the friction coefficient μ can be made to not less than 0.030 in all stands of No. 1 to 4. Therefore, the stands (passes) on the upstream side is advantageous to the rolling at an increased friction coefficient.

<Experiment 2>

In order to confirm the influence of the friction coefficient in the cold rolling upon the magnetic properties of the product sheet, a steel slab having a component composition comprising C: 0.0015 mass %, Si: 3.2 mass %, Mn: 0.18 mass %, P: 0.07 mass %, S: 0.0015 mass %, sol. Al: 0.0008 mass %, N: 0.0018 mass %, Sn: 0.06 mass % and the remainder being Fe and inevitable impurities is reheated at 1100° C. for 30 minutes and hot rolled to form a hot-rolled sheet having a sheet thickness of 1.6 mm. The hot-rolled sheet is then subjected to a hot-band annealing by soaking at 1050° C. for 60 seconds and cooling at 25° C./sec in a continuous annealing furnace, pickled to remove scale and cold rolled with a 4-stand tandem rolling mill in a pass schedule shown in Table 1 to obtain a cold-rolled sheet having a final sheet thickness of 0.18 mm. In this case, the kinetic viscosity v₅₀ of the rolling oil is adjusted in No. 2 stand which is advantageous to an increase in the friction coefficient to variously change the friction coefficient μ in the rolling as shown in Table 2, while the rolling oil having the kinetic viscosity v₅₀ at 50° C. of 50 mm²/s is used in the other stands to render the friction coefficient μ into not more than 0.022. Then, the cold-rolled sheet is subjected to a finish annealing at 1000° C. in a dry nitrogen-hydrogen atmosphere for 10 seconds and coated with an insulation coating to obtain a product sheet.

Ring (annular) samples with an outer diameter of 45 mm and an inner diameter of 33 mm are punched out from the obtained product sheet. After 10 samples are laminated, primary winding and secondary winding are each wound 100 turns to measure a magnetic flux density B₅₀ and an iron loss W_{10/400}, and the measurement results are also shown in Table 2. As seen from these results, the steel sheet having the higher friction coefficient μ in the rolling at No. 2 stand, particularly the steel sheet obtained by rolling at the friction coefficient μ of not less than 0.030 has excellent magnetic properties.

TABLE 2

| | | | | | | | Texture | | |
|---|---|---|---|---|---|---|---|---|---|
| | Cold rolling conditions | | | | Magnetic properties | | Intensity of | Intensity of | |
| | Upper stage: Kinetic viscosity v₅₀ of rolling oil (mm²/s) | | | | Magnetic | Iron loss | {111}<112> | {110}<001> | |
| | Lower stage: Friction coefficient μ (—) | | | | flux density | W_{10/400} | orientation | orientation | |
| No. | No.1 stand | No.2 stand | No.3 stand | No.4 stand | B₅₀(T) | (W/kg) | (xrandom) | (xrandom) | Remarks |
| 1 | 50 | 50 | 50 | 50 | 1.56 | 11.5 | 3.80 | 0.20 | Comparative Example |
| | 0.022 | 0.020 | 0.015 | 0.010 | | | | | |
| 2 | 50 | 45 | 50 | 50 | 1.60 | 10.9 | 3.50 | 0.26 | Comparative Example |
| | 0.022 | 0.025 | 0.015 | 0.010 | | | | | |
| 3 | 50 | 40 | 50 | 50 | 1.68 | 10.3 | 2.80 | 0.50 | Invention Example |
| | 0.022 | 0.030 | 0.015 | 0.010 | | | | | |
| 4 | 50 | 35 | 50 | 50 | 1.70 | 10.0 | 2.54 | 0.84 | Invention Example |
| | 0.022 | 0.032 | 0.015 | 0.010 | | | | | |
| 5 | 50 | 30 | 50 | 50 | 1.72 | 9.8 | 2.21 | 1.09 | Invention Example |
| | 0.022 | 0.035 | 0.015 | 0.010 | | | | | |

To investigate the reason for the changes in the magnetic properties as mentioned above, a test sample is taken out from the product sheet after the finish annealing and intensities of {110}<001> orientation and {111}<112> orientation at a layer of ⅕ of its sheet thickness are measured by X-ray diffraction. Concretely, the test sample, the thickness of which is reduced by polishing to a layer of ⅕ of the sheet thickness, is etched with 10% nitric acid for 30 seconds, and thereafter positive pole figures of (110), (200) and (211) faces are measured by X-ray Schultz method. From the measurement data, ODF (Orientation Distribution Function) analysis is performed to calculate an intensity of each crystal orientation. The analysis is performed using a software of ResMat company, Textools and calculated by ADC (Arbitrarily Defined Cell) method.

The analysis results are also shown in Table 2. It is considered from these results that, in the steel sheet rolled at a friction coefficient μ of not less than 0.030 in rolling at No. 2 stand, the intensity of {111}<112> orientation which is disadvantageous to the magnetic properties is deceased to not more than 3, while the intensity of {110}<001> orientation which is advantageous to the magnetic properties is increased to not less than 0.45, resulting that excellent magnetic properties being high in the magnetic flux density B₅₀ and low in the iron loss W_{10/400} are obtained.

The inventors consider that the reason for the decrease in the intensity of {111}<112> orientation and the increase in the intensity of {110}<001> orientation in the steel sheet rolled at a friction coefficient μ of not less than 0.030 in rolling is due to the fact that crystal rotation from {111}<112> orientation which is disadvantageous to the magnetic properties to {110}<001> orientation which is advantageous to the magnetic properties in the cold rolling is caused by increasing the friction coefficient.

<Experiment 3>

In order to investigate an influence of a rolling reduction upon the effect of improving the magnetic properties by increasing the friction coefficient, the steel slab, which is prepared in Experiment 2, is reheated at 1100° C. for 30 minutes and hot rolled to form a hot-rolled sheet having a sheet thickness of a value at an entry side of No. 1 stand shown in Table 3. The hot-rolled sheet is then pickled to remove scale and cold rolled in a 4-stand tandem rolling mill to form a cold-rolled sheet having a final sheet thickness of 0.18 mm. In this case, friction coefficients in No. 1 stand, No. 2 stand, No. 3 stand and No. 4 stand of the rolling mill are adjusted to 0.022, 0.030, 0.015 and 0.010, respectively, and the sheet thickness of the hot-rolled sheet is adjusted so as to change only the rolling reduction in No. 2 stand as shown in Table 3. Then, the cold-rolled sheet is subjected to a finish annealing in a dry nitrogen-hydrogen atmosphere at 1000° C. for 10 seconds and coated with an insulation coating to obtain a product sheet.

TABLE 3

| | Cold rolling conditions | | | | | | Texture | | |
|---|---|---|---|---|---|---|---|---|---|
| | Upper stage: Sheet thickness at entry side (mm) | | | | Magnetic properties | | Intensity of | Intensity of | |
| | Middle stage: Sheet thickness at exit side (mm) | | | | Magnetic | Iron loss | {111}<112> | {110}<001> | |
| | Lower stage: Rolling reduction (%) | | | | flux density | W_{10/400} | orientation | orientation | |
| No. | No. 1 stand | No. 2 stand | No. 3 stand | No. 4 stand | B₅₀(T) | (W/kg) | (xrandom) | (xrandom) | Remarks |
| 1 | 0.89 | 0.67 | 0.60 | 0.30 | 1.59 | 11.0 | 3.54 | 0.27 | Comparative Example |
| | 0.67 | 0.60 | 0.30 | 0.18 | | | | | |
| | 25 | 10 | 50 | 40 | | | | | |
| 2 | 0.91 | 0.68 | 0.60 | 0.30 | 1.60 | 10.9 | 3.20 | 0.31 | Comparative Example |
| | 0.68 | 0.60 | 0.30 | 0.18 | | | | | |
| | 25 | 12 | 50 | 40 | | | | | |
| 3 | 0.94 | 0.71 | 0.60 | 0.30 | 1.66 | 10.5 | 2.80 | 0.50 | Invention Example |
| | 0.71 | 0.60 | 0.30 | 0.18 | | | | | |
| | 25 | 15 | 50 | 40 | | | | | |
| 4 | 1.00 | 0.75 | 0.60 | 0.30 | 1.68 | 10.4 | 2.78 | 0.52 | Invention Example |
| | 0.75 | 0.60 | 0.30 | 0.18 | | | | | |
| | 25 | 20 | 50 | 40 | | | | | |

The magnetic flux density B₅₀ and iron loss W_{10/400} of the thus-obtained product sheet are measured, and the intensities of {110}<001> orientation and {111}<112> orientation in the layer of ⅕ of the sheet thickness of the steel sheet after the finish annealing are calculated in the same method as in Experiment 2.

The results are also shown in Table 3. As seen from these results, although the friction coefficient in No. 2 stand is adjusted to 0.030, the intensity of {111}<112> orientation cannot be made to not more than 3 and the intensity of {110}<001> orientation cannot be made to not less than 0.45 without controlling the rolling reduction in the corresponding pass to not less than 15%, and hence the effect of improving the magnetic properties according to the invention cannot be obtained. The reason thereof is considered due to the fact that the crystal rotation from {111}<112> orientation to {110}<001> orientation is insufficient when the rolling reduction is low.

The invention is developed by further studies based on the above novel knowledge.

There will be described the component composition of a raw steel material used in a production of a non-oriented electrical steel sheet according to the invention below.

C: not more than 0.005 mass %

When C is contained in an amount exceeding 0.005 mass %, the product sheet causes magnetic aging to deteriorate the iron loss. Therefore, the upper limit of C content is 0.005 mass %, preferably not more than 0.003 mass %.

Si: 1.0 to 5.0 mass %

Si has an effect of increasing specific resistance of steel to reduce the iron loss and thus is added in an amount of not less than 1.0 mass %. However, when Si is added in an amount exceeding 5.0 mass %, steel becomes brittle to cause breakage in the cold rolling. Therefore, the Si content is within the range of 1.0 to 5.0 mass %. Preferably, it is within the range of 2.5 to 4.0 mass %.

Mn: 0.04 to 3.0 mass %

Mn has an effect of forming MnS with S to be coarsely precipitated, preventing hot brittleness of steel as well as improving grain growth. Mn also has an effect of increasing specific resistance of steel to reduce iron loss, and thus is added in an amount of not less than 0.04 mass %. When Mn is added in an amount exceeding 3.0 mass %, however, the above effects are saturated to bring about not only increase in costs but also decrease in the magnetic flux density. Therefore, Mn content is controlled within the range of 0.04 to 3.0 mass %. Preferably, it is within the range of 0.1 to 1.0 mass %.

sol. Al: not more than 0.005 mass %

When Al content exceeds 0.005 mass % as sol. Al, fine A1N is precipitated in the hot-band annealing to block the grain growth in the hot-band annealing and/or the finish annealing. Therefore, Al content is limited to not more than 0.005 mass % as sol. Al. Preferably, P is not more than 0.002 mass %.

P: not more than 0.2 mass %

P has an effect of segregating into a grain boundary to increase magnetic flux density. Also, P has an effect of adjusting the hardness of steel to improve the punchability. However, when it is added in an amount exceeding 0.2 mass %, steel is embrittled to easily cause breakage in the cold rolling. Therefore, P content is not more than 0.2 mass %. Preferably, it is not more than 0.15 mass %.

S: not more than 0.005 mass %

When S content exceeds 0.005 mass %, precipitates of MnS and the like are increased to block grain growth. Therefore, the upper limit of S content is 0.005 mass %. Preferably, it is not more than 0.003 mass %.

N: not more than 0.005 mass %

When N content exceeds 0.005 mass %, precipitates of AlN and the like are increased to block the grain growth. Therefore, the upper limit of N content is 0.005 mass %. Preferably, it is not more than 0.003 mass %.

In the non-oriented electrical steel sheet according to the invention, the remainder other than the above ingredients is Fe and inevitable impurities. For the purpose of improving the magnetic properties and the like, one or more selected from the following ingredients may be contained in addition to the above essential ingredients.

Sn, Sb: 0.005 to 0.2 mass % each

Sn and Sb have an effect of reducing grains of {111} orientation in recrystallization texture to increase the magnetic flux density, and thus each can be added in an amount of not less than 0.005 mass %. However, when it is added in an amount exceeding 0.2 mass %, the above effect is saturated. Therefore, Sn and Sb contents are each preferable to be within the range of 0.005 to 0.2 mass %, more preferably within the range of 0.01 to 0.15 mass %.

REM, Mg, Ca: 0.0005 to 0.02 mass % each

REM, Mg and Ca have an effect of forming sulfide to be coarsened and improving the grain growth, and each ingredient can be added in an amount of not less than 0.0005 mass %. However, when the addition amount exceeds 0.02 mass %, the grain growth is rather deteriorated, so that each of REM, Mg and Ca is preferable to be within the range of 0.0005 to 0.02 mass %. More preferably, it is within the range of 0.001 to 0.01 mass %.

There will be described a method for producing a non-oriented electrical steel sheet according to the invention below.

The non-oriented electrical steel sheet according to the invention can be produced by a usually known production method comprising a series of steps of subjecting a raw steel material (slab) having the aforementioned component composition to hot rolling, hot-band annealing, cold rolling and finish annealing.

The raw steel material used in the production of a non-oriented electrical steel sheet according to the invention may be produced by a conventionally known method, for example, by a method that molten steel obtained in a converter, an electric furnace or the like is adjusted to have the aforementioned component composition by a usual refining process of conducting secondary refining in a vacuum degassing apparatus or the like and then shaped into a steel slab by a continuous casting method or an ingot making-blooming method. Also, the raw steel material may be a thin slab produced by a thin slab casting machine to have a thickness of not more than 100 mm.

Then, the slab is reheated to a given temperature and hot rolled to form a hot-rolled sheet having a given sheet thickness. The hot rolling may be performed under usually known rolling conditions, which are not particularly limited. Moreover, when the predetermined hot-rolling temperature can be secured, the slab after the casting may be subjected to hot rolling immediately without reheating. Also, when the thin slab is produced by the thin slab casting machine, the slab may be hot rolled or advanced to the subsequent step without hot rolling.

The hot-rolled sheet after the hot rolling is subjected to a hot-band annealing for the purpose of improving the magnetic properties. The annealing conditions may be usually known conditions and are not particularly limited.

The steel sheet after the hot-band annealing is descaled by pickling or the like and subjected to cold rolling, which is the most important step in the invention, to form a cold-rolled sheet having a final sheet thickness. In the cold rolling, the final sheet thickness may be obtained by single rolling, or two or more cold rollings having an intermediate annealing between each rolling. Here, the final cold rolling refers to, when the final steel thickness is obtained by a single cold rolling, the single cold rolling, while, when the final sheet thickness is obtained by two or more cold rolling having an intermediate annealing between each rolling, it refers to the last cold rolling after the last intermediate annealing. The final cold rolling is preferable to be conducted so that the total rolling reduction is not less than 80%. When the total rolling reduction is not less than 80%, the sharpness of the texture can be enhanced to improve the magnetic properties. Moreover, the upper limit of the total rolling reduction is not particularly limited, but when it exceeds 98%, the rolling cost is remarkably increased, so that not more than 98% is preferable. More preferably, it falls within the range of 85 to 95%.

The rolling mill used in the final cold rolling may be a tandem rolling mill or a Sendzimir rolling mill as far as the rolling is conducted at one or more pass. From a viewpoint of increasing productivity to reduce production costs, it is preferable to use a tandem rolling mill.

In the invention, it is most important that it is necessary to conduct a cold rolling at a rolling reduction of not less than 15% and a high friction coefficient μ of not less than 0.030 in at least one pass of the final cold rolling, as mentioned above. Moreover, the pass corresponds to a stand when a tandem rolling mill is used, but the term “pass” will be hereinafter used in the description. Performing a cold rolling at a high rolling reduction and high friction coefficient can introduce shear strain into {111} fiber texture and promote the formation of grains of {110}<001> orientation. It is preferable that the rolling reduction is not less than 25% and the friction coefficient μ is not less than 0.04.

When the friction coefficient is adjusted through the kinetic viscosity of the rolling oil as shown in FIG. 1, it is preferable to use a rolling oil having a kinetic viscosity v₅₀ at 50° C. of not more than 40 mm²/s, whereby the friction coefficient μ can be not less than 0.030 at one or more stands when the rolling is performed in the 4-stand tandem rolling mill. Further, the kinetic viscosity v₅₀ is preferably not more than 15 mm²/s which allows the friction coefficient to be not less than 0.030 at all stands.

When the final cold rolling is conducted at the n-th pass after the second pass, the rolling at a high rolling reduction and a high friction coefficient may be conducted at any pass, but it is preferable to be conducted at a pass from the 2nd pass to the (n−1)-th pass just before the final pass. The reason is as follows. Since there are few {111} orientation textures to be a base of {110}<001> orientation recrystallization nuclear in the steel sheet after the hot-band annealing or the intermediate annealing, even when a high friction rolling is performed at the first pass, the effect of forming {110}<001> orientation grains is small, while the final pass needs to secure rolling property for shape control secured. In particular, when the number of passes is small, the above rolling is preferable to be applied to a stand on the upstream side, from a viewpoint of increasing the friction coefficient μ by the kinetic viscosity v₅₀ of the rolling oil.

The method of increasing the friction coefficient in the rolling includes a method of increasing a roughness of a work roll, a method of decreasing a rolling speed and the like in addition to the method of reducing the kinetic viscosity of the rolling oil as described above, and either method may be used as far as the high friction coefficient can be stably adjusted in a wide range.

Moreover, the rolling temperature of the final cold rolling is not particularly limited, but it is preferable to adopt warm rolling of raising a steel sheet temperature to 100 to 250° C. and perform the rolling because it has an effect of further improving the magnetic properties through the improvement of the texture.

Thereafter, the cold-rolled sheet with the final sheet thickness after the final cold rolling is subjected to a finish annealing under usually known conditions and coated with an insulation coating, if necessary, to form a product sheet. The insulation coating may use a well-known inorganic coating, organic coating, inorganic-organic mixed coating and the like in accordance with required properties and purpose, and is not particularly limited.

### EXAMPLE 1

A steel having a component composition comprising C: 0.0015 mass %, Si: 3.2 mass %, Mn: 0.18 mass %, P: 0.07 mass %, S: 0.0015 mass %, sol. Al: 0.0008 mass %, N: 0.0018 mass %, other component composition of Sn, Sb, REM, Mg and Ca as shown in Table 4 and the remainder being Fe and inevitable impurities is melted to form a steel slab. The slab is reheated at 1100° C. for 30 minutes and hot rolled to form a hot-rolled sheet having a sheet thickness of 1.6 mm. Then, the hot-rolled sheet is subjected to a hot-band annealing of soaking at 1050° C. for 60 seconds and cooling at 25° C./sec in a continuous annealing furnace, pickled to remove scale and cold rolled to form a cold-rolled sheet having a final sheet thickness of 0.18 mm. In this case, conditions of a rolling oil and a rolling reduction allocation in the cold rolling are shown in Table 5. Then, the cold-rolled sheet is subjected to a finish annealing in a dry nitrogen-hydrogen atmosphere at 1000° C. for 10 seconds and coated with an insulation coating to form a product sheet.

Plural ring (annular) samples having an outer diameter of 45 mm and an inner diameter of 33 mm are punched out from the thus-obtained product sheet, and then 10 samples are laminated. Around the coil, primary winding and secondary winding are each wound by 100 turns, and a magnetic flux density B₅₀ and an iron loss W_{10/400} are measured. Intensities of {110}<001> orientation and {111}<112> orientation in a layer of ⅕ of the steel sheet thickness after the finish annealing are analyzed by an X-ray diffraction. Concretely, the sample is polished to ⅕ of the sheet thickness and etched with 10% nitric acid for 30 seconds, and then positive pole figures of (110), (200), (211) faces are measured by an X-ray Schultz method, and ODF (Orientation Distribution Function) analysis is conducted from the measurement data to calculated an intensity of each crystal orientation. The analysis is performed using a software of ResMat company, Textools and calculated by ADC (Arbitrarily Defined Cell) method.

The measurement results are also shown in Table 4. As seen from these results, the magnetic properties are more improved in the steel sheets (Steel No. B to I) added with one or more of Sn, Sb, REM, Mg and Ca as compared to the steel sheet not added with the above elements (Steel No. A).

TABLE 4

| | | | | | | Magnetic properties | | |
|---|---|---|---|---|---|---|---|---|
| Steel | Other addition ingredients (mass %) | | | | | Magnetic flux | Iron loss | |
| symbol | Sn | Sb | REM | Mg | Ca | density B₅₀ (T) | W_{10/400} (W/kg) | Remarks |
| A | — | — | — | — | — | 1.68 | 10.3 | Invention Example |
| B | 0.05 | — | — | — | 0.002 | 1.71 | 9.8 | Invention Example |
| C | 0.05 | — | — | — | 0.0025 | 1.75 | 8.9 | Invention Example |
| D | — | 0.06 | 0.002 | — | — | 1.76 | 8.7 | Invention Example |
| E | — | 0.02 | — | 0.002 | — | 1.72 | 9.7 | Invention Example |
| F | — | — | 0.001 | — | — | 1.74 | 9.5 | Invention Example |
| G | — | — | — | 0.002 | — | 1.73 | 9.4 | Invention Example |
| H | — | — | — | — | 0.002 | 1.70 | 9.1 | Invention Example |
| I | — | 0.06 | — | — | — | 1.75 | 8.8 | Invention Example |

—: no addition

TABLE 5

| | Cold rolling conditions | | | |
|---|---|---|---|---|
| | No. 1 | No. 2 | No. 3 | No. 4 |
| | stand | stand | stand | stand |
| Kinetic viscosity ν₅₀ of | 50 | 40 | 50 | 50 |
| rolling oil (mm²/s) | | | | |
| Friction coefficient μ(−) | 0.022 | 0.030 | 0.015 | 0.010 |
| Rolling reduction (%) | 25 | 50 | 50 | 40 |

### EXAMPLE 2

A steel slab having a component composition comprising C: 0.0015 mass %, Si: 3.2 mass %, Mn: 0.18 mass %, P: 0.07 mass %, S: 0.0015 mass %, sol. Al: 0.0008 mass %, N: 0.0018 mass %, Sn: 0.06 mass % and the remainder being Fe and inevitable impurities is reheated at 1100° C. for 30 minutes and hot rolled to form a hot-rolled sheet having a sheet thickness of 1.6 mm. The hot-rolled sheet is then subjected to a hot-band annealing by soaking at 1050° C. for 60 seconds and cooling at 25° C./sec in a continuous annealing furnace, pickled to remove scale and cold rolled with a 4-stand tandem rolling mill to obtain a cold-rolled sheet having a sheet thickness of 0.18 mm. In the cold rolling, a kinetic viscosity v₅₀ of a rolling oil supplied to each stand is adjusted so that friction coefficients of No. 1 to No. 4 stands take values shown in Table 6, and also a rolling reduction of each stand is allocated as shown in Table 6. Then, the cold-rolled sheet is subjected to a finish annealing in a dry nitrogen-hydrogen atmosphere at 1000° C. for 10 seconds and coated with an insulation coating to form a product sheet.

As to the product sheet, the magnetic flux density B₅₀ and iron loss W_{10/400} are measured by the same method as in Example 1, and intensities of {110}<001> orientation and {111}<112> orientation in the layer of ⅕ of the steel sheet thickness after the finish annealing are calculated. The results are also shown in Table 6. As seen from these results, the intensity of {111}<112> orientation is rendered into not more than 3 and the intensity of {110}<001> orientation is rendered into not less than 0.45 by making the friction coefficient to not less than 0.030 and the rolling reduction to not less than 15% in one or more stands (pass), whereby electrical steel sheets having excellent magnetic properties are obtained.

TABLE 6

| | | | | | | | Texture | | |
|---|---|---|---|---|---|---|---|---|---|
| | Cold rolling conditions | | | | Magnetic properties | | Intensity of | Intensity of | |
| | Upper stage: Rolling reduction (%) | | | | Magnetic flux | Iron loss | {111}<112> | {110}<001> | |
| | Lower stage: Friction coefficient μ (—) | | | | density | W_{10/400} | orientation | orientation | |
| No. | No. 1 stand | No. 2 stand | No. 3 stand | No. 4 stand | B₅₀ (T) | (W/kg) | (xrandom) | (xrandom) | Remarks |
| 1 | 25 | 50 | 50 | 40 | 1.65 | 10.5 | 2.75 | 0.45 | Invention Example |
| | 0.030 | 0.020 | 0.015 | 0.010 | | | | | |
| 2 | 25 | 50 | 50 | 40 | 1.68 | 10.3 | 2.80 | 0.50 | Invention Example |
| | 0.022 | 0.030 | 0.015 | 0.010 | | | | | |
| 3 | 25 | 50 | 50 | 40 | 1.67 | 10.0 | 2.60 | 0.61 | Invention Example |
| | 0.022 | 0.020 | 0.030 | 0.010 | | | | | |
| 4 | 25 | 50 | 50 | 40 | 1.66 | 9.8 | 2.56 | 0.72 | Invention Example |
| | 0.022 | 0.020 | 0.015 | 0.030 | | | | | |
| 5 | 25 | 50 | 50 | 40 | 1.72 | 9.7 | 2.42 | 0.82 | Invention Example |
| | 0.022 | 0.030 | 0.030 | 0.010 | | | | | |
| 6 | 25 | 50 | 50 | 40 | 1.73 | 9.6 | 2.39 | 0.85 | Invention Example |
| | 0.022 | 0.030 | 0.015 | 0.030 | | | | | |
| 7 | 25 | 50 | 50 | 40 | 1.56 | 11.5 | 3.80 | 0.20 | Comparative Example |
| | 0.022 | 0.020 | 0.015 | 0.010 | | | | | |

1. A method for producing a non-oriented electrical steel sheet comprising a series of steps of:
subjecting a raw steel material having a component composition comprising C: not more than 0.005 mass %, Si: 1.0 to 5.0 mass %, Mn: 0.04 to 3.0 mass %, sol. Al: not more than 0.005 mass %, P: not more than 0.2 mass %, S: not more than 0.005 mass %, N: not more than 0.005 mass % and the remainder being Fe and inevitable impurities to a hot rolling to form a hot-rolled sheet,
subjecting the hot-rolled sheet to a hot-band annealing and then to a single cold rolling or two or more cold rollings including an intermediate annealing between each cold rolling to form a cold-rolled sheet having a final sheet thickness, and subjecting the cold-rolled sheet to a finish annealing,
wherein
at least one pass in a final cold rolling of the cold rolling is a rolling conducted at a friction coefficient μ of not less than 0.030 and a rolling reduction of not less than 15%, where the final cold rolling refers to, when the final sheet thickness is achieved by a single cold rolling, the single cold rolling, or when the final sheet thickness is achieved by two or more cold rollings including an intermediate annealing between each rolling, a last cold rolling conducted after a last intermediate annealing.

2. The method for producing a non-oriented electrical steel sheet according to claim 1, wherein
a rolling oil having a kinetic viscosity v₅₀ at 50° C. of not more than 40 mm²/s is used in the final cold rolling.

3. The method for producing a non-oriented electrical steel sheet according to claim 1, wherein
the raw steel material contains one or more selected from Sn: 0.005 to 0.2 mass %, Sb: 0.005 to 0.2 mass %, REM: 0.0005 to 0.02 mass %, Mg: 0.0005 to 0.02 mass % and Ca: 0.0005 to 0.02 mass % in addition to the above component composition.

4. The method for producing a non-oriented electrical steel sheet according to claim 2, wherein
the raw steel material contains one or more selected from Sn: 0.005 to 0.2 mass %, Sb: 0.005 to 0.2 mass %, REM: 0.0005 to 0.02 mass %, Mg: 0.0005 to 0.02 mass % and Ca: 0.0005 to 0.02 mass % in addition to the above component composition.
